(19) United States
(12) Patent Application Publication
(10) Pub. No.: US 2014/0011389 A1
(43) Pub. Date: Jan. 9, 2014

(54) CONNECTOR

(71) Applicant: YAZAKI CORPORATION, Tokyo (JP)

(72) Inventor: Yoshifumi SHINMI, Makinohara-shi (JP)

(21) Appl. No.: 13/933,500

(22) Filed: Jul. 2, 2013

(30) Foreign Application Priority Data
Jul. 3, 2012 (JP) 2012-149404

(51) Int. Cl. H01R 13/62

(52) U.S. Cl. CPC H01R 13/62
USPC 439/370

(57) ABSTRACT

An connector includes a housing and connection terminals. The housing includes chambers each to be inserted one of the connection terminals, flexible lances each having one free end and the other end secured in respective chamber, and communication holes each communicating with an outside through the housing on the side of the free end of each of the lances. Each of the connection terminal includes a wire connection portion to be connected with a wire W, a terminal body formed to allow inserted into each of the chambers, and a lance engagement portion formed engageable with each of the lances. In a cross direction perpendicular to the inserting direction of each of the connection terminal into the housing, the lance engagement portion is formed to have a width narrower than a width of each of the lances and a width of each of the communicating holes.

### BACKGROUND OF THE INVENTION

1. Field of the Invention

The present invention relates to a connector having a housing and connection terminals.

2. Description of the Related Art

Conventionally, there have been proposed a variety of engagement structures (i.e. retaining structures) for connection terminals inserted into a housing of a connector. As illustrated in FIG. 1, this type of connector 100 includes a housing 110 and a plurality of connection terminals 120 to be inserted to the housing 110 (see US 2011/0117795A1).

The housing 110 includes chambers 111 each to be inserted each of the connection terminals 120 and flexible lances 112 each having one free end and the other end secured in each of the chambers 111. A front end of each of the lances 112 is provided with a step portion 113 with which a jig (not illustrated) for lifting up each of the lances 112 is to be engaged.

Each of the connection terminals 120 includes a wire connection portion 121 to be connected with a wire W and a box-shaped terminal body 122 to be inserted into each of the chambers 111. The terminal body 122 is provided with a lance engagement portion 123 for engaging with the lance 112.

When one of the connection terminals 120 is inserted into one of the chambers 111, the lance engagement portion 123 comes into contact with one of the lances 112, causing a displacement of one of the lances 112. Subsequently, when the lance engagement portion 123 passes through the lance 112, the lance 112 is engaged with the lance engagement portion 123, preventing the connection terminal 120 from escaping from the chamber 111.

Meanwhile, in case of detaching the connection terminal 120 from the housing 110, it is necessary to cancel the engagement between the lance 112 and the lance engagement portion 123 with use of the jig. Therefore, the housing 110 has communication holes 114 each formed on the side of the free end of the lance 112 to communicate with an outside. By inserting the jig into the communication hole 114 and successively lifting up the step portion 113 of the lance 112, it is possible to cancel the engagement between the lance 112 and the lance engagement portion 123.

### SUMMARY OF THE INVENTION

In the conventional connector 100, however, there is a possibility that the jig inserted into the communication hole 114 interferes with the connection terminal 120 (for example, the terminal body 122 or the lance engagement portion 123) in detaching the connection terminal 120 from the housing 110, causing the connection terminal 120 to be damaged disadvantageously.

Therefore, an object of the present invention is to provide a connector which prevents an interference of a jig with a terminal in detaching the terminal from a housing, so that the breakage of the terminal can be avoided.

In order to solve the problem described above, a connector according to a first aspect of the present invention includes a housing; and connection terminals each to be inserted into the housing. The housing includes chambers each to be inserted one of the connection terminals, flexible lances each having one free end and the other end secured in respective chamber, and communication holes each communicating with an outside through the housing on a side of the free end of each of the lances. Each of the connection terminals includes a wire connection portion to be connected with a wire, a terminal body formed to allow inserted into each of the chambers, and a lance engagement portion formed engageable with each of the lances. The lance engagement portion is formed, along a cross direction perpendicular to an inserting direction of each of the connection terminals into the housing, with a width which is narrower than a width of each of the lances and a width of each of the communicating holes each along the cross direction.

In the connector according to the first aspect, additionally, there is no need of providing the front end of the lance with a step portion which has been required for its engagement with the inserted jig in the conventional connector. Therefore, the configuration of the housing can be simplified to make a contribution of reducing the quantity of housing material. Thus, it is possible to reduce the manufacturing cost of the connector.

The lance engagement portion may be unevenly arranged so that a center thereof in the cross direction deviates from a center of the terminal body in the cross direction.

Consequently, it is possible to prevent the jig inserted into the communication hole from interfering with the lace engagement portion certainly.

Each of the communicating holes may include a first hole section formed to penetrate through a wall defining each of the chambers, and a second hole section which is formed to adjacent to the first hole section and allows inserting a jig for cancelling an engagement between the lance and the lance engagement portion. The second hole section may be formed in a tapered shape.

Consequently, it is possible to facilitate inserting of the jig into the second hole section, allowing the jig inserted into the communication hole to be guided to an area making no interference with the lance engagement portion. Thus, it is possible to prevent the jig inserted into the communication hole from interfering with the lance engagement portion more certainly.

According to the first aspect of the present invention, therefore, it is possible to provide a connector which prevents a jig from interfering with a terminal in detaching the terminal from a housing, so that the breakage of the terminal can be avoided.

### BRIEF DESCRIPTION OF THE DRAWINGS

FIG. 1 is a side view of a conventional connector described in the description of the related art.

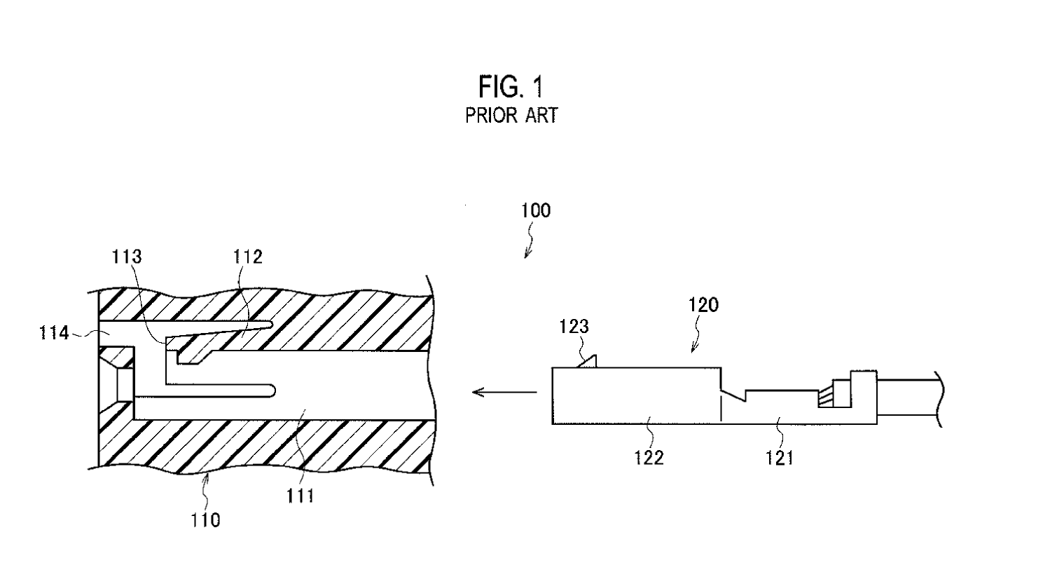

FIG. 2 is an exploded perspective view of a connector according to an embodiment of the present invention.

FIG. 3 is an assembling perspective view of the connector according to the embodiment.

FIG. 4 is a sectional view of the connector according to the embodiment.

FIGS. 5A and 5B are perspective views of a connection terminal according to the embodiment, also viewed from the side of a top wall of the terminal.

FIGS. 6A and 6B are perspective views of the connection terminal according to the embodiment, also viewed from the side of a bottom wall of the terminal.

FIG. 7 is a development view of the connection terminal according to the embodiment.

FIG. 8 is a plan view of the connector at its disengagement, according to the embodiment.

### DESCRIPTION OF THE EMBODIMENTS

A connector according to an embodiment of the present invention will be explained with reference to the drawings. In the following description of the drawings, the same or similar reference numerals or signs will be affixed to the same or similar portions. However, it should be noted that the drawings are schematic and, therefore, ratios or the like of each dimension are different from those of the actual ones. Thus, specific dimensions or the like should be determined by referring to the following explanation. Further, among the drawings, portions having mutually different dimensional relations or mutually different dimensional ratios may be included.

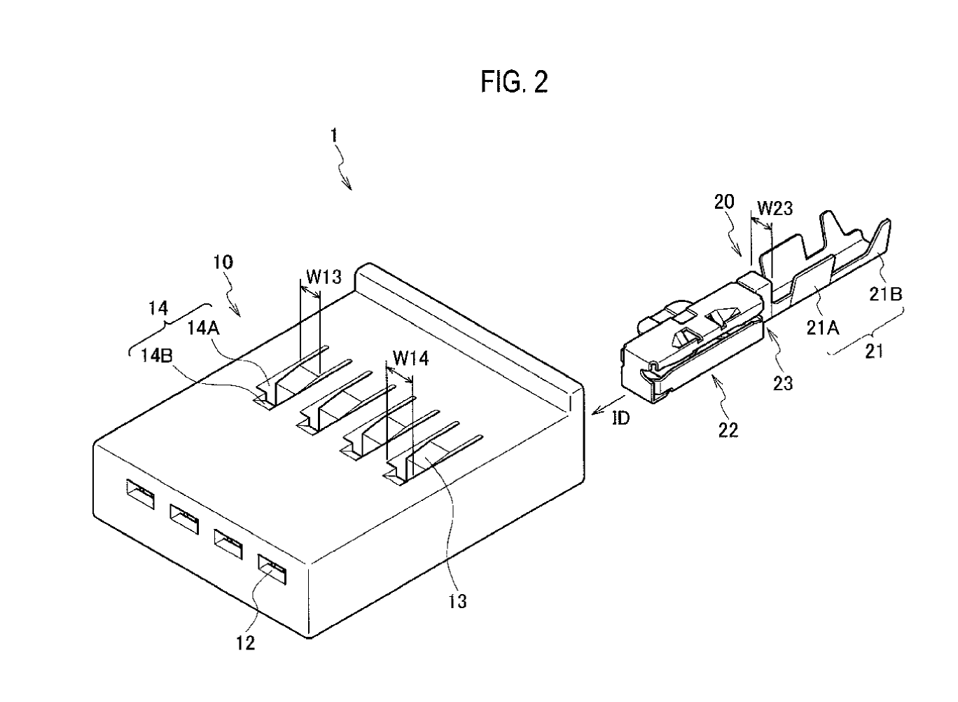

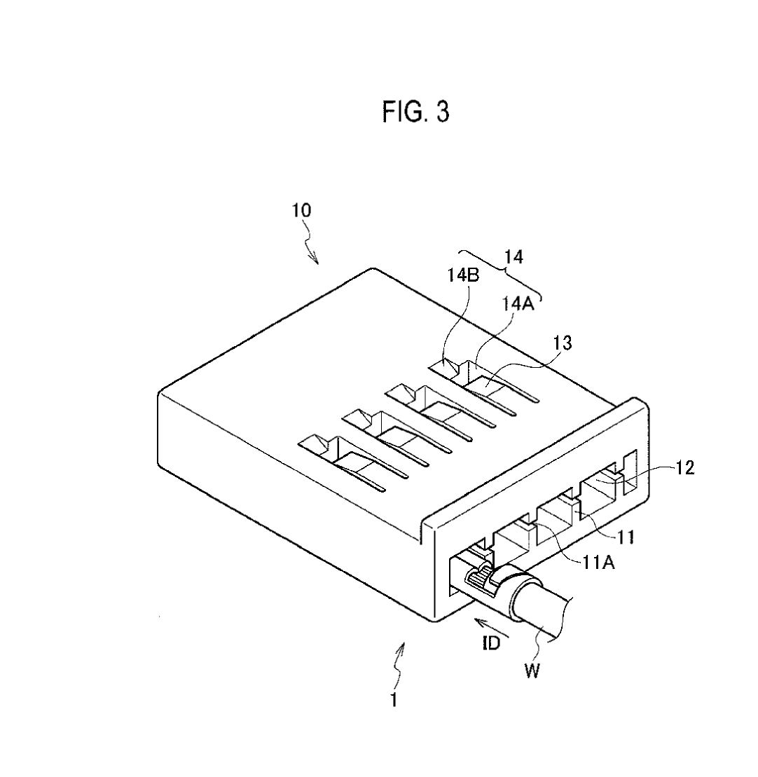

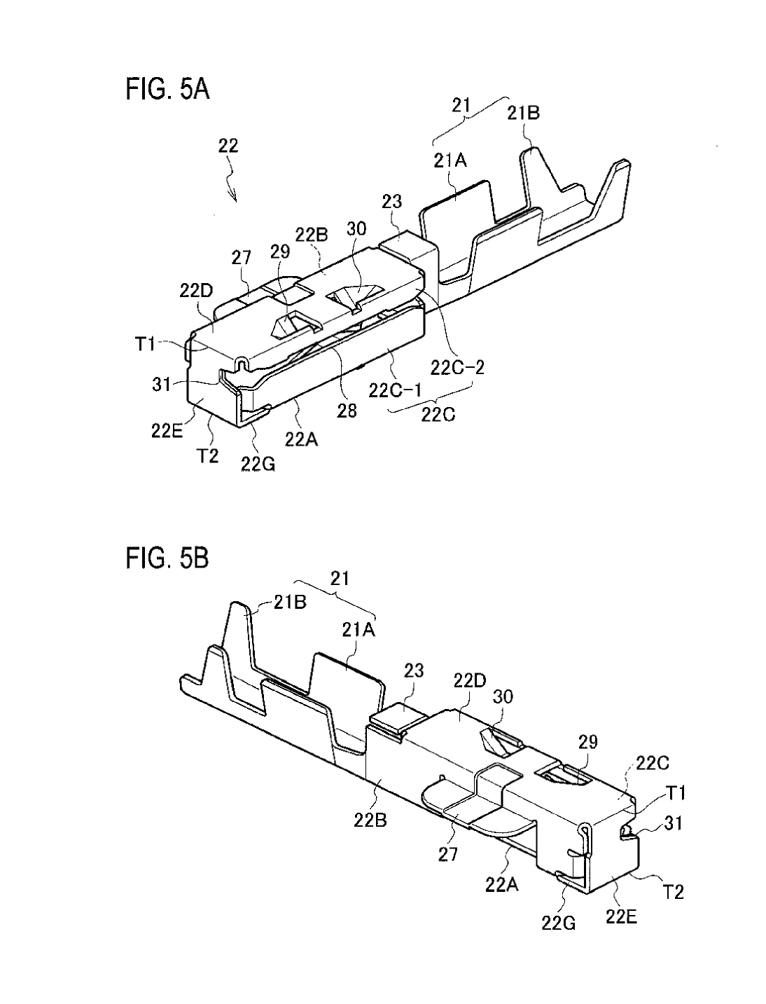

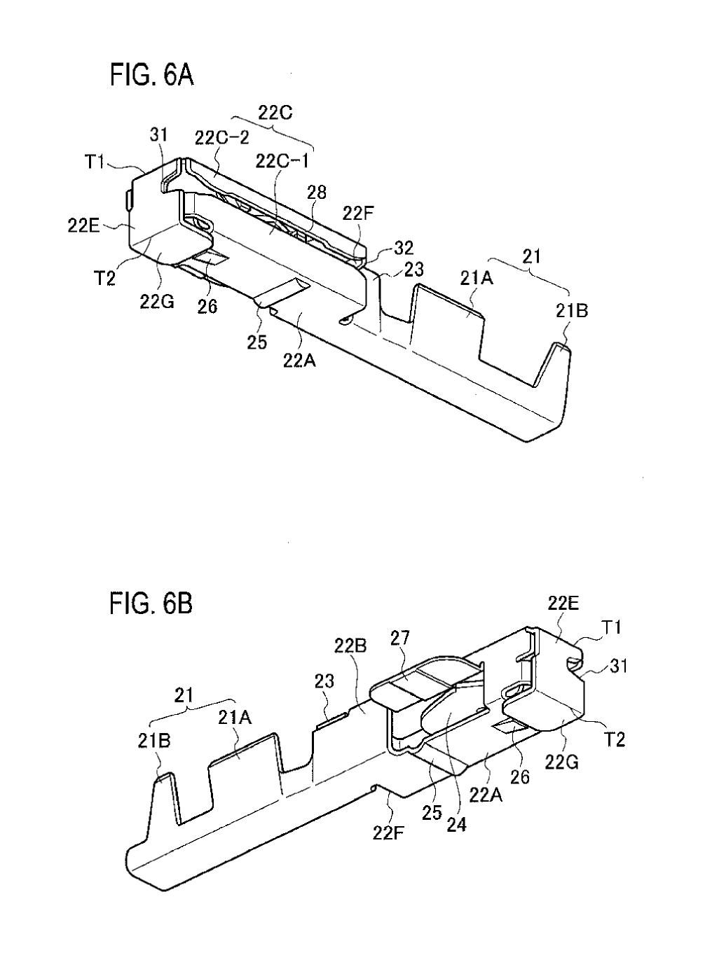

The constitution of the connector 1 according to the embodiment will be explained with reference to FIGS. 2 to 7. As illustrated in FIGS. 2 to 4, the connector 1 includes a housing 10 and a plurality of connection terminals 20 accommodated in the housing 10, and electrically connects each of the connection terminals 20 inserted into the housing 10. In FIGS. 2 and 3, there is illustrated only one connection terminal 20 while omitted the other connection terminals.

The housing 10 includes a plurality of chambers 12 which are partitioned by partition walls 11 respectively and into which the connection terminals 20 are inserted, a plurality of flexible lances 13 protruding into the chambers 12 in a displaceable manner, and a plurality of communication holes 14 each communicating with a free end side of each of the lances 13 to an outside in the housing 10.

Each of the partition walls 11 is provided with a communication groove 11A communicating the adjacent chambers 12 with each other (see FIG. 3). The communication groove 11A is arranged in a position deviating from a center of each of the chambers 12 in the vertical direction (e.g. upper side in the embodiment).

Each of the lances 13 is constructed as a cantilever, which has one free end and the other end secured in each of the chambers 12. Each of the lances 13 has an inclined surface 13A formed on the interior side and a planar engagement surface 13a formed on the leading-end side.

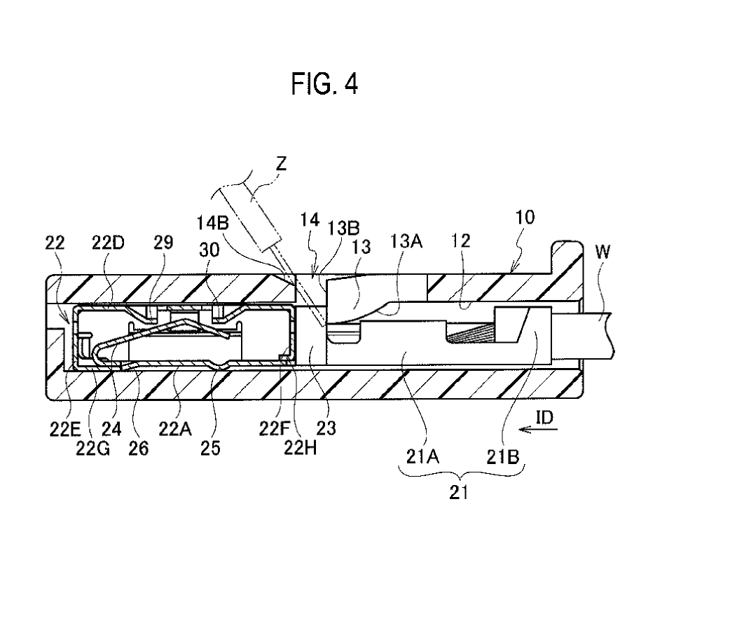

Each of the communication holes 14 is formed so as to penetrate through a wall (e.g. a top surface in the embodiment) of each of the chambers 12. Each of the communication holes 14 includes a first hole section 14A and a second hole section 14B adjacent to the first hole section 14A. Inserted into the second hole section 14B is a jig Z (see FIG. 4) which serves to cancel an engagement between the lance 13 and the connection terminal 20 (e.g. lance engagement portion 23 described later).

The second hole section 14B has a tapered shape so as to gradually get broader as approaching to the outside of the housing 10.

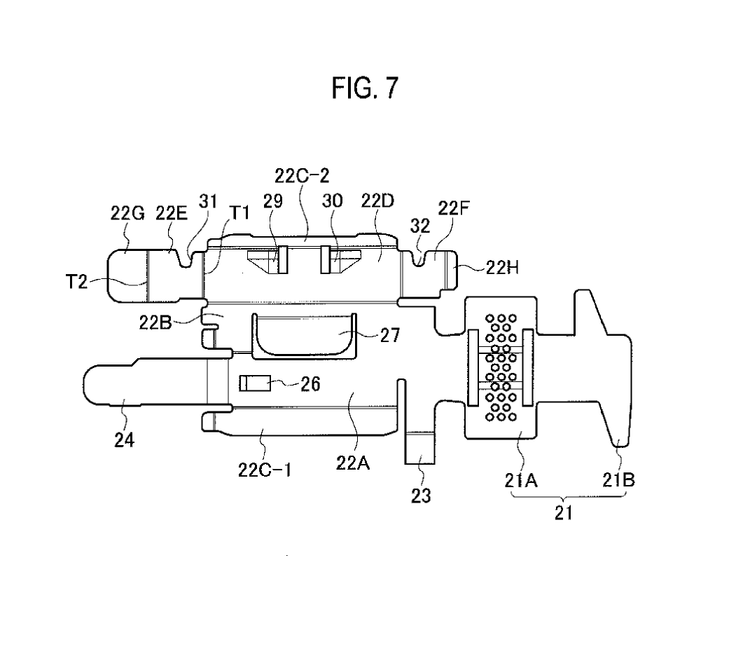

The connection terminal 20 is provided by bending a conductive plate having a predetermined shape as illustrated in FIG. 7. The connection terminal 20 includes a wire connection portion 21 to be connected with a wire W (see FIGS. 3 and 4), a box-shaped terminal body 22 formed integrally with the wire connection portion 21, and a lance engagement portion 23 arranged on a side of the terminal body 22 closer to the wire connection portion 21 and to be engaged with the lance 13.

The wire connection portion 21 includes a core crimp portion 21A for crimping a core of the wire W and an insulation crimp portion 21B for crimping an insulation covering the core of the wire W. In order to avoid a contact with a male contact piece 27 of an adjacent connection terminal 20 when the connection terminal 20 is inserted into the housing 10, the wire connection portion 21 is unevenly arranged to one side wall of the terminal body 22 (closer to a first side wall 22B, in the embodiment).

The terminal body 22 is arranged along a direction extending from a front end toward a rear end of the connection terminal 20. Note, this direction will be referred to as “inserting direction ID” of the connection terminal 20 into the housing 10. The terminal body 22 includes a bottom wall 22A, a first side wall 22B, a second side wall 22C, and a top wall 22D, each extending along the inserting direction ID of the connection terminal 20, and a front wall 22E and a rear wall 22F both extending in a direction intersecting with the inserting direction ID of the connection terminal 20.

An elastic portion 24 is formed integrally with the bottom wall 22A, in the form of a cantilever folded back from the front end side of the connection terminal 20 in the inserting direction ID. In the terminal body 22, the elastic portion 24 is brought into contact with the adjacent terminal body 22 (i.e. a male contact piece 27 described later).

The bottom wall 22A includes a protrusion 25 protruding outward of the bottom wall 22A and an inclined piece 26 arranged the front side of the protrusion 25 in the inserting direction ID of the connection terminal 20 into the housing 10. In order to ensure the balancing of the connection terminal 20 in the housing 10, the protrusion 25 is formed so as to protrude toward a position corresponding to the thickness of a front end turned-back portion 22G bent from the front wall 22E (i.e. a thickness of the conductive plate). The inclined piece 26 is inclined toward the front end turned-back portion 22G, preventing it from getting stuck with the chamber 12 in withdrawing the connection terminal 20 from the housing 10.

The first side wall 22B is provided with a male contact piece 27 protruding therefrom by bending a portion of the first side wall 22B outward in a horizontal direction. Corresponding to the communication groove 11A, the male contact piece 27 is arranged in a position deviating from a center of the first side wall 22B in the vertical direction (e.g. on the top wall 22D side of the first side wall 22B in the embodiment). When the connection terminal 20 is fitted to the housing 10, the male contact piece 27 is inserted into the communication groove 11A.

The second side wall 22C is opposed to the first side wall 22B. The second side wall 22C includes a lower second side wall 22C-1 obtained by bending a periphery of the bottom wall 22A and an upper second side wall 22C-2 obtained by bending a periphery of the top wall 22D partially. The lower second side wall 22C-1 and the upper second side wall 22C-2 are separated from each other in the vertical direction.

That is, the second side wall 22C is provided with a slit 28 which allows inserting the male contact piece 27 of the adjacent connection terminal 20. In the second side wall 22C, the slit 28 is formed so as to penetrate through the terminal body 22 along the inserting direction ID. Similarly to the male contact piece 27, the slit 28 is arranged in a position deviating from the center of the second side wall 22C in the vertical direction, corresponding to the communication groove 11A (e.g. on one side of the second side wall 22C closer to the top wall 22D in the embodiment). On both sides of the slit 28 in the inserting direction ID, it is formed so as to gradually increase a slit width as directing to the outside (i.e. toward the front wall 22E and the rear wall 22F) from the center of the second side wall 22C.

The top wall 22D is formed by bending a portion of the first side wall 22B. The top wall 22D is provided with a first contact portion 29 and a second contact portion 30 each protruding toward the inner side of the terminal body 22. Accordingly, when the connection terminal 20 is fitted to the housing 10, the male contact piece 27 is inserted into the slit 28 of the adjacent connection terminal 20 through the communication groove 11A and successively pinched between the elastic portion 24 and the first and second contact portions 29, 30. Consequently, two adjacent terminal bodies 22, that is, two adjacent connection terminals 20 are electrically connected with each other.

The front wall 22E is arranged at the front end of the terminal body 22 in the inserting direction ID to close up a front opening of the terminal body 22. The front wall 22E is provided by bending a portion of the top wall 22D. The front wall 22E is followed by the front end turned-back portion 22G folded back to an outer side of the bottom wall 22A to abut on it. A bent part T1 between the front wall 22E and the top wall 22D and a bent part T2 between the front wall 22E and the front end turned-back portion 22G are respectively provided with curvatures or chamfers.

The rear wall 22F is positioned on the rear side of the front wall 22E in the inserting direction ID to close up a rear opening of the terminal body 22. The rear wall 22F is provided by bending a portion of the top wall 22D. The rear wall 22F is followed by a rear turned-back portion 22H folded back to the inner side of the bottom wall 22A to abut on it.

The front wall 22E is provided with a first cutout 31 in a position along the slit 28. The rear wall 22F is provided with a second cutout 32 in a position along the slit 28. The first and second cutouts 31, 32 are formed so as to allow a passage of the male contact piece 27 therethrough, respectively. The first and second cutouts 31, 32 are formed so as to correspond to respective positions of the male contact piece 27 and the slit 28. The first and second cutouts 31, 32 are formed so as to open against the slit 28 and become narrower gradually as directing from the second side wall 22C to the first side wall 22B.

Similarly to the wire connection portion 21, the lance engagement portion 23 is unevenly arranged to one side wall of the terminal body 22 (closer to the first side wall 22B). The lance engagement portion 23 is formed so that its width W23 along the cross direction CD becomes narrower than a width W13 of the lance 13 along the cross direction, and a width W14 of the communication hole 14 (i.e. a width of the first hole section 14A and the second hole section 14B), as well (see FIG. 2).

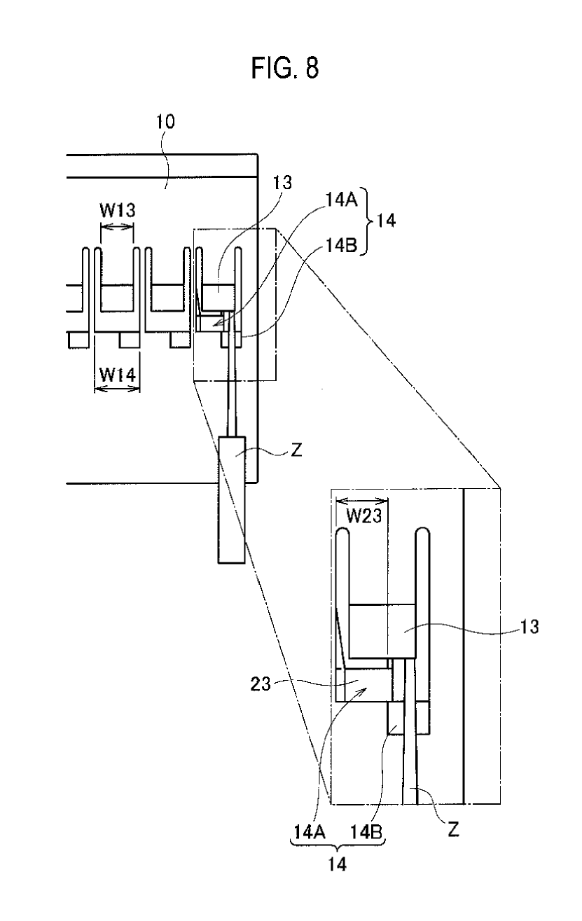

The assembling/detaching method of the connector 1 will be explained in brief, with reference to FIG. 8.

First, insert the connection terminal 20 into one of the chambers 12 of the housing 10. Then, the male contact piece 27 is gradually inserted into the slit 28 of the adjacent connection terminal 20 through the second cutout 32, the communication groove 11A, and the first cutout 31 of the adjacent connection terminal 20. During this inserting, the connection terminal 20 comes into contact with the inclined surface 13A of the lance 13, causing a displacement of the lance 13.

Then, when the connection terminal 20 is completely fitted in the housing 10 (see FIGS. 3 and 4), the male contact piece 27 is pinched between the elastic portion 24 and the first and second contact portions 29, 30. Consequently, two adjacent terminal bodies 22 (i.e. two adjacent connection terminals 20) are electrically connected with each other. Then, the engagement surface 13b of the lance 13 is engaged with the lance engagement portion 23, preventing the connection terminal 20 from escaping from the chamber 12.

Meanwhile, when detaching the connection terminal 20 from the housing 10, the jig Z may be used to cancel the engagement between the lance 13 and the lance engagement portion 23. As illustrated in FIGS. 4 and 8, by inserting the jig Z into the second hole section 14B of the communication hole 14 and successively lifting up the lance 13, the engagement between the lance 13 and the lance engagement portion 23 is cancelled. Then, since the lance engagement portion 23 is unevenly arranged to one side wall of the terminal body 22, it is possible to prevent the jig Z from interfering with the lance engagement portion 23.

The width W23 of the lance engagement portion 23 is narrower than the width W14 of the lance 13 and the width W14 of the communication hole 14. Consequently, a space allowing inserting the jig Z for lifting up the lance 13 is defined around the lance engagement portion 23. Thus, when detaching the terminal 20 from the housing 10, it is possible to prevent the jig Z inserted into the communication hole 14 from interfering with the lance engagement portion 23 of the connection terminal 20, preventing a breakage of the connection terminal 20.

In the connector 1 according to the embodiment, there is no need of providing the front end of the lance 13 with a step portion 113 of the conventional connector 100, which has been required for its engagement with the jig. Therefore, the configuration of the housing 10 can be simplified to make a contribution of reducing the quantity of housing material. Thus, it is possible to reduce the manufacturing cost of the connector 1.

The lance engagement portion 23 is unevenly arranged to one side wall of the terminal body 22. Consequently, it is possible to prevent the jig Z inserted into the communication hole 14 from interfering with the lance engagement portion 23 more certainly.

The second hole section 14B has the tapered shape so as to gradually get broader as approaching to the outside of the housing 10. Consequently, it is possible to facilitate inserting of the jig Z into the second hole section 14B, allowing the jig Z inserted into the communication hole 14 to be guided to an area making no interference with the lance engagement portion 23. Thus, it is possible to prevent the jig Z inserted into the communication hole 14 from interfering with the lance engagement portion 23 more certainly.

As described above, although the contents of the present invention has been disclosed through the exemplary embodiment, the descriptions and drawings constituting a part of this disclosure should not be understood as ones limiting the present invention. From this disclosure, various alternative embodiments and operational techniques would be apparent to those skilled in the art.

The configuration of the connector 1 is not limited to that described in the illustrated embodiment and therefore, it may be established appropriately.

The communication groove 11A is not necessarily to be formed on the upper side of the vertical center of the chamber 12 and therefore, they may be formed at the vertical center of the chamber 12 or on the lower side of the vertical center. In connection, the male contact piece 27, the slit 28, and the first and second cutouts 31, 32 have only to be formed corresponding to the position of the communication grooves 11A.

The communication hole 14 has been explained as penetrating through the wall defining the chamber 12 (e.g. a top surface in the embodiment). Nevertheless, not limited to this configuration, the communication hole 14 may be alternatively opened on one side of the chamber 12, as described in the description of the related art.

The wire connection portion 21 is not necessarily to be unevenly arranged to one side wall of the terminal body 22 (closer to the first side wall 22B). The wire connection portion 21 may be arranged so as not to deviate from the terminal body 22.

The lance engagement portion 23 has been explained as to be unevenly arranged to one side wall of the terminal body portion 22 (closer to the first side wall 22B), the positioning is not limited to this. For instance, even if the lance engagement portion 23 is arranged so as not to deviate from the terminal body 22, the width W23 of the lance engagement portion 23 has only to be narrower than the width 13 of the lance 13 and the width 14 of the communication hole 14. That is, a clearance has only to be ensured in the housing 10 so that the jig Z inserted into the communication hole 14 does not interfere with the lance engagement portion 23.

In this way, it is matter of course that the present invention contains a variety of embodiments not described herein. Thus, the technical scope of the present invention would be defined only by proper inventive specific matters which are proper from the above explanation and recited in the scope of claims.

What is claimed is:

1. A connector comprising:
a housing; and a plurality of connection terminals each to be inserted into the housing, wherein
the housing includes:
a plurality of chambers each to be inserted one of the connection terminals;
a plurality of flexible lances each having one free end and the other end secured in respective chamber; and
a plurality of communication holes each communicating with an outside through the housing on a side of the free end of each of the lances, each of the connection terminals includes:
a wire connection portion to be connected with a wire;
a terminal body formed to allow inserted into each of the chambers; and
a lance engagement portion formed engageable with each of the lances, and the lance engagement portion is formed, along a cross direction perpendicular to an inserting direction of each of the connection terminals into the housing, with a width which is narrower than a width of each of the lances and a width of each of the communicating holes each along the cross direction.

2. The connector of claim 1, wherein the lance engagement portion is unevenly arranged so that a center thereof in the cross direction deviates from a center of the terminal body in the cross direction.

3. The connector of claim 1, wherein
each of the communicating holes includes a first hole section formed to penetrate through a wall defining each of the chambers, and a second hole section which is formed to adjacent to the first hole section and allows inserting a jig for cancelling an engagement between the lance and the lance engagement portion, and
the second hole section is formed in a tapered shape.
